(19) United States
(12) Patent Application Publication
(10) Pub. No.: US 2025/0225547 A1
(43) Pub. Date: Jul. 10, 2025

(54) METHOD AND SYSTEM FOR SHARING RESOURCES AMONG DIFFERENT ENTITIES VIA A CLOUD APPLICATION

(71) Applicant: 9F Smartlink Technology Inc., Daly City, CA (US)

(72) Inventors: Lucy Liu, Daly City, CA (US); Guno Sutiono, Daly City, CA (US)

(21) Appl. No.: 18/407,304

(22) Filed: Jan. 8, 2024

(51) Int. Cl. G06Q 30/0251; G06Q 30/0214; G06Q 30/0241; G06Q 50/00

(52) U.S. Cl. CPC G06Q 30/0259; G06Q 30/0214; G06Q 30/0258; G06Q 30/0277; G06Q 50/01

(57) ABSTRACT

Techniques described herein disclose a resource-sharing system that includes one or more client devices and one or more cloud servers to connect brick-and-mortar entities, web-based entities, and individuals within a centralized cloud application dedicated to resource sharing.

### TECHNICAL FIELD

Apparatuses, systems, and methods are to cause one or more devices to communicate and share information with other devices in a network. For example, a system comprising one or more processors are to use scan codes and web-based applications to connect different devices and entities together for resource sharing.

### BACKGROUND

In today's digital landscape, some brick-and-mortar entities lack resources to effectively engage in web services. As a workaround, brick-and-mortar entities often resort to using third-party services to attract users. However, the user retention rate from such strategies is typically low, and these users are easily swayed towards web-based entities for different products or services. Consequently, brick-and-mortar entities struggle to reap long-term benefits from users acquired through paid messages. Meanwhile, web-based entities face their own set of challenges, particularly in finding efficient channels that attract high-quality, loyal users.

### BRIEF DESCRIPTION OF THE DRAWINGS

Various techniques will be described with reference to the drawings, in which:

FIG. 1 illustrates a schematic diagram of a resource-sharing system according to an embodiment;

FIG. 2 illustrates the resource-sharing system according to an embodiment;

FIG. 3 illustrates a recommendation component in an application which can recommend items to each user for sharing with other users according to an embodiment;

FIG. 4 illustrates an example connection hierarchy according to an embodiment;

FIG. 5 illustrates a process of serving new users of the application according to an embodiment;

FIG. 6 illustrates a process of sharing values among entities through the application according to an embodiment; and

FIG. 7 illustrates aspects of an example system for implementing aspects in accordance with an embodiment

### DETAILED DESCRIPTION

Techniques herein describe a resource-sharing system that includes a plurality of client devices and a server application (e.g., a cloud service) in a cloud environment to connect traditional brick-and-mortar entities, web-based entities, and individuals together for resource sharing. Each user of the application is assigned a unique scan code, which can be used to register new users with the application. New users joining through an existing user are integrated into that user's connection hierarchy. A user earns values (e.g., referral points) for consumption of items advertised on the application by others within the user's connection hierarchy.

A web-based entity user can display the scan code in a physical or virtual place. A non-user individual who encounters the scan code can scan it to join the application, and subsequently be added to the entity user's connection hierarchy. Individual users may have the option to promote service-advertised items (e.g., products or services) to their contacts using their own code. Contacts who join the application by scanning this code may then be added to the referrer's hierarchy.

The system offers various resources to attract traffic from all involved parties. This way, an entity user provides a free space to promote their offerings to individual users, who could be current or potential clients. For individual users, the application provides value-added resources, such as free lectures and classes, to draw traffic from these individuals to the application. These individual users are also incentivized to use the application both for its discounts on advertised items and for the opportunity to earn values (e.g., referral points) by drawing new users.

In the preceding and following description, various techniques are described. For purposes of explanation, specific configurations and details are set forth in order to provide a thorough understanding of possible ways of implementing the techniques. However, it will also be apparent that the techniques described below may be practiced in different configurations without specific details. Furthermore, well-known features may be omitted or simplified to avoid obscuring the techniques being described.

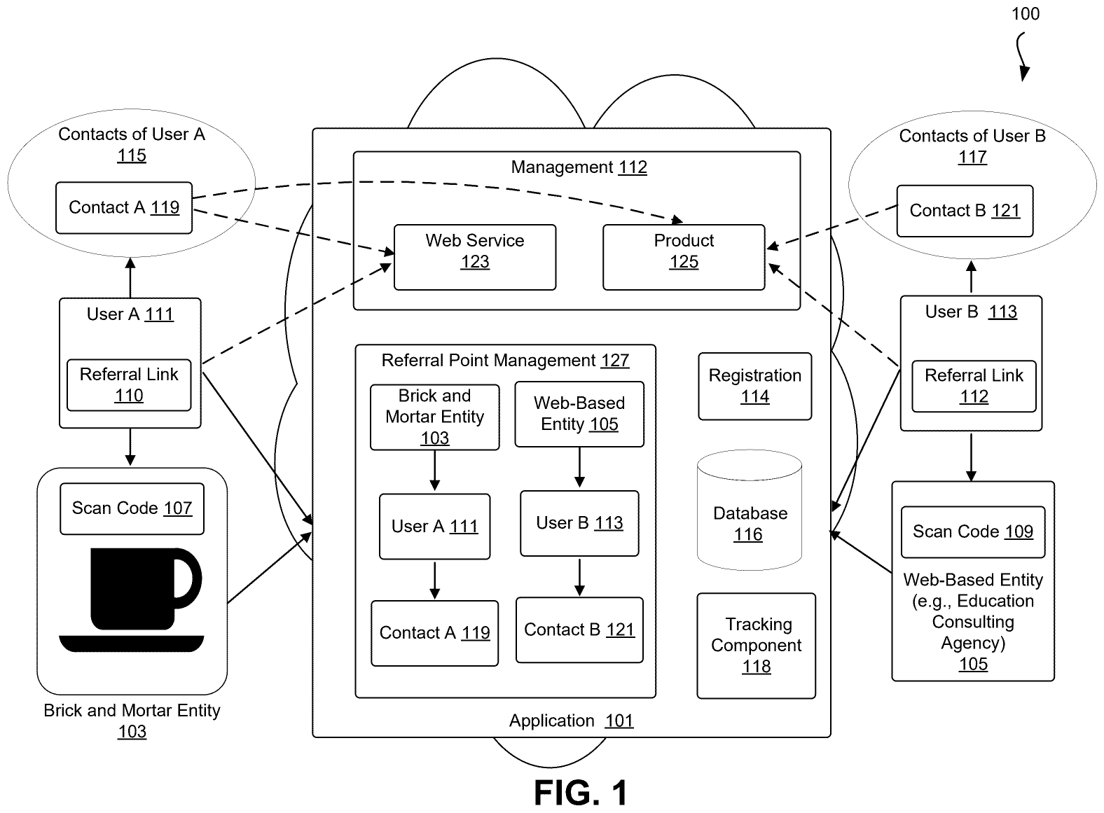

FIG. 1 illustrates a schematic diagram of a resource-sharing system 100 according to an embodiment of the disclosure. The system 100 can include an application 101, which may be a server application that is responsible for managing data, handling user requests, and providing services to client applications. For the simplicity of illustration, FIG. 1 does not show all components in the application 101. For example, FIG. 1 does not show Application Programming Interfaces (APIs) that define interfaces through which client applications interact with the application 101. The APIs may be implemented using various technologies, such as Representational State Transfer (REST) and Simple Object Access Protocol (SOAP). The networking layer manages the communication between the server application and the client application, and handles network protocols, such as TCP/IP, and ensures that data is transmitted securely and reliably. Furthermore, while certain functions or features are described as being performed by one specific component or module in FIG. 1, these functions or features are not limited to that component or module in other embodiments. Instead, they can be performed by a combination and/or different components or modules.

In an embodiment, the server application can be deployed on a variety of servers, including cloud servers, dedicated servers, virtual machines, and/or a combination thereof. The choice of server may depend on the application's requirements, such as performance, scalability, and security. In an embodiment, the application can run a multi-node cloud system, where the operations for providing the resource-sharing system 100 can be distributed across multiple processing nodes to increase the system's scalability, fault tolerance, and performance in terms of processing speed of the system. Further, data related to the operations can be loaded into a distributed shared memory (DSM) to be accessed by multiple processing nodes. The DSM enhances the system's scalability since it allows more processing nodes to be added as more processing power is needed. As the system expands, the system may offer increased memory resources to the applications, boosting overall performance. Further, the DSM facilitates the efficient use of memory resources spread across different machines. If a node is grappling with high memory consumption, it has the capability to tap into the unused memory of other nodes, enhancing the adaptability of the cloud-based computing system.

In an embodiment, the resource-sharing system 100 also includes client devices used by users or potential users 111 and 113 to interact with the application 101. The types of client devices in FIG. 1 can include personal computers, e.g., desktops, laptops, and netbooks; mobile devices, e.g., smartphones, tablets, and wearables; and home and entertainment devices, e.g., smart TVs, gaming consoles, and smart home devices. Each client device may include a compatible client application. Each client application may be a user interface that users interact with to access the application.

For example, a mobile client application can include a graphical user interface (GUI), an application logic, and a networking component. The GUI can have buttons, menus, forms, and other UI elements that users interact with the application 101 to participate in the resource-sharing system 100. The application logic implements the user interactions and handles data processing on the client device and may also communicate with the server application to fetch data or submit requests. The networking component is a layer that manages the communication between the mobile client application and the server application.

In an embodiment, the application 101 includes a registration component 114, a promotion management component 114, a tracking component 118, and a referral point management component 127.

The registration component 114 is responsible for registering new users of the application. An individual person can register with the application 101 at the introduction of an existing user using the existing user's unique scan code (e.g., QR code) or unique registration code. Upon registering, the new user receives a unique scan used to identify all activity of the new user and is placed in a connection hierarchy of the existing user. Further, the registration component 114 can be used to register entities that need to promote their items on the application 101 for free. An entity user is not placed under any existing user's hierarchy unless the entity is registered as an individual user. The registration component 114 can create a profile on the system 100 for each user to a database 116. The database 116 can further store item information, order details, and other information that can be used to track their activities, referrals, and the hierarchy of relationships formed through the referral process. The database 116 can be either relational, NoSQL, or a combination of both.

In an embodiment, a registration component 114 can include a set of APIs that enable items of entity users to be displayed on a client device of each user (entity user or individual user). The promotion management 114 can catalog these items, managing information like descriptions, availability, and any special terms; determine discounts for the items; generate a unique referral link for each promotion to enable an individual user to promote an item to social media contacts of the user. In an embodiment, the referral link can include the scan code of the individual user, the scan code of the entity user providing the item, and identifying information of the item itself, such that when a user consumes the item via the referral link, the promoting user can be identified to be properly credited. In addition, the promotion management component 114 may calculate values earned by users through their referral activities and may keep an accurate record of all transactions to ensure the correct distribution of these values according to a set of predetermined distribution rules or a predetermined distribution algorithm.

In an embodiment, the promotion management component 114 can enable users to manage their activities, view their place in referral hierarchies, track their earned values, and access items through their client devices. In an embodiment, the promotion management component 114 implements a set of rules to ensure that all activities are conducted in compliance with relevant laws and regulations. For example, the promotion management component 114 can determine whether a particular promotion violates legal or ethical rules based on the profession of the promoting user or the nature of the item to be promoted. The promotion management component 114 can receive updates regarding changes in laws and regulations, keeping the activities compliant over time. It can also allow for customization of rules based on the specific needs and policies of an entity.

In an embodiment, the promotion management component 114 can provide reports on activities. The reports can include data on the most successful referral chains, popular items, user engagement, etc. These insights can be used by users to optimize their strategies and by the system administrators to improve the application. These reports can be stored in the database to train an artificial intelligence model for recommending items to be promoted to individual users.

In an embodiment, the tracking component 118 can construct and maintain a structured hierarchy of referrals, placing each new user within an existing user's connection hierarchy. The tracking component 118 can monitor and record the consumption patterns of products or services by users within the system 100. This consumption is not limited to web-based interactions but also includes transactions made at physical, brick-and-mortar entities through the system's integration. The scan code of each user and identifying information of each promoted items can be used for the purposes of consumption tracking.

In an embodiment, the referral point management component 127 can distribute rewards, points, or monetary benefits to users based on their position within the connection hierarchies. It determines the amount of value to be allocated to each user when a consumption action occurs within their connection hierarchies. Further, the referral point management component 127 may maintain a real-time view of the connection hierarchy, ensuring that values are accurately assigned following the system's rules and further keep track of the addition of new users and the subsequent reshaping of the hierarchy.

As further shown, the referral point management component 127 maintains a real-time view of two referral hierarchies constructed by the tracking component 118. One of the referral hierarchies includes a brick-and-mortar entity user 103 at the top of the hierarchy, with individual user A 111 and contact A 119 below. This hierarchy is called the connection hierarchy of the a brick-and-mortar entity user 103. In this disclosure, a connection hierarchy is named after the user at the highest level of the hierarchy. A hierarchy can include one or more sub-hierarchies, and each sub-hierarchy can be named after the user at the highest level of the sub-hierarchy. Thus, the sub-hierarchy including user A 111 and contact A 119 can be referred to as the connection hierarchy of user A 111. In an embodiment, a user in a connection hierarchy can derive values from any consumption by any user below the user.

In an embodiment, a brick-and-mortar entity connection hierarchy can be constructed by the tracking component 118 as a result of activities of user A 111. As shown, the brick-and-mortar entity (e.g., a coffee shop) has registered with the application 101 as an entity user of the application. The brick-and-mortar entity 103 can have its assigned scan code 107 printed on the wall or menu of the brick-and-mortar entity 103. In an embodiment, user A 111 has not registered with the application 101 when visiting the brick-and-mortar entity 103. After scanning the scan code 107, user A 111 is prompted for registration. After a successful registration, the application 101 can notify user A 111 via text message or email. Since user A 111 in this scenario was brought to the application 101 by scanning the scan code of the brick-and-mortar entity 103, user A 111 can be placed in the connection hierarchy of the brick-and-mortar entity 103. As shown, user A 111 also promotes one or more items on the application 101 to social media contacts or other contacts 115 and contact A 119 among contacts 115 of user A 111 is brought to the application 101 after scanning a referral link 110 (e.g., web-based link) and registers with the application as an individual user. Contact A 119 is therefore placed in referral the hierarchy of user A 111.

In an embodiment, the other hierarchy with a web-based entity 105 at the top can be similarly constructed. For example, a potential user may have visited the website of the web-based entity and scan a scan code 109 of the web-based entity 105, which is a registered entity user. The scanning can cause the potential user to register with the application 101 as user B 113, which subsequently promotes service-advertised items to contacts 117 and contact B 121 then registers with the application 101 by scanning a referral link 112.

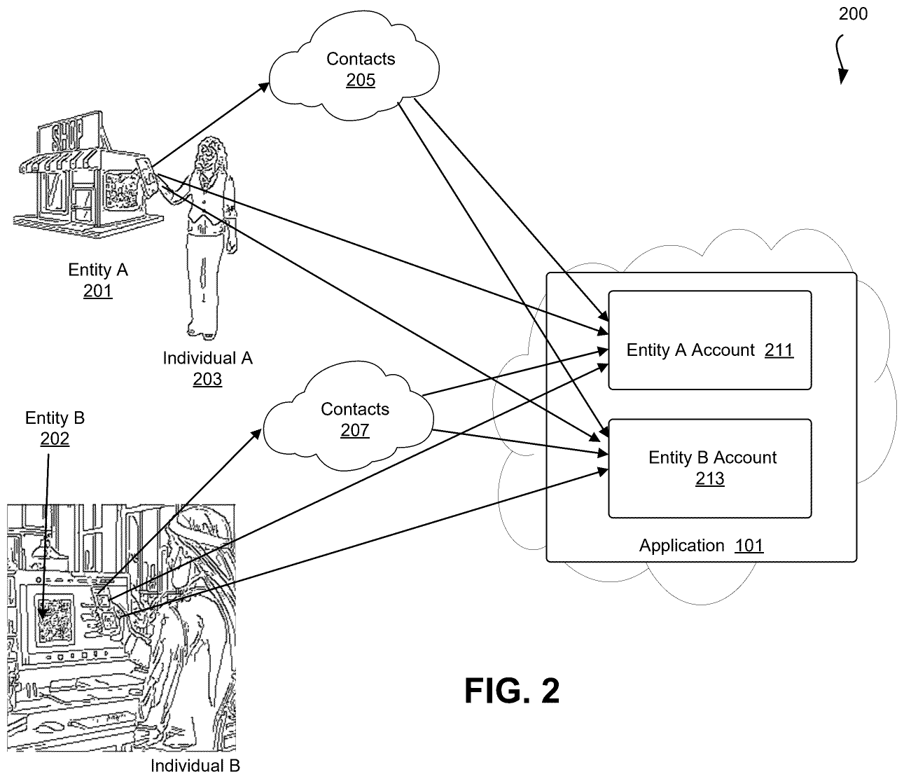

FIG. 2 illustrates the resource-sharing system 200 according to an embodiment of the disclosure. More specifically, FIG. 2 illustrates how different types of entities can benefit from the consumption of each other's visitors on the application 101 such that the different types of entities are bridged together. Thus, a traditional brick-and-mortar entity can blend into web-based presence through the application 101, and a web-based entity can indirectly increase their user base through the application 101. In an embodiment, a web-based entity refers to any organization or business that maintains an online presence. This term encompasses a wide range of entities operating on traditional internet platforms and in emerging digital spaces such as the metaverse. These entities may engage in various online activities including, but not limited to, offering products or services, disseminating information, facilitating communication, or providing interactive experiences.

As shown, in an embodiment, entity A 201 is a brick-and-mortar entity and entity B 202 is a web-based entity. The two entities 201 and 202 have their own accounts 211 and 213 set up for storing referral points and purchase orders. The application 101 can provide free value-added web-based resources, such as newsworthy information and web-based lectures from professionals (e.g., accounts and attorneys), to draw individuals to the application 101. These individuals may have registered with the application 101 previously at the introduction of existing users or would be interested in registering after visiting the application 101. Therefore, those interested in registering can scan a scan code of an existing user or his unique registration code to register with the application 101 as a new user. Entities can advertise their products using a web service 123 provided by web-based entity 105 or using services of physical stores (e.g., a product 125 provided by the brick-and-mortar entity 103) on the application 101 because the application 101 provides space for the entities to advertise their products or services to a large number of users of the application 101. Participants are willing to consume these platform-advertised items because of the discounts available to users of the application 101.

Individual A 203 can scan a scan code of entity A 201 on the wall of entity A 201 to register as a user in a connection hierarchy of entity A 201, and individual B 204 can scan a bar code of entity B 202 posted on a website of entity B 202 to register as a user in a hierarchy of entity B 202. After becoming a user of the application 101, each user may selectively promote service-advertised items to their respective circle of contacts (e.g., social media contacts) and at least one contact in their respective circle may join the platform 101 after seeing their promotions.

In an embodiment, if individual A 203 or individual B 204 is already a user within a different hierarchy prior to scanning the respective scan code, the application 101 would not alter the existing hierarchical structure. Instead, the platform 101 would send future promotions to the individual user.

In an embodiment, each of the accounts 211 and 213 can benefit from each of the individuals/users 203 and 204 and benefit from each of contact-turned users among the contacts 205 and 207.

As an example, individual A 203 can benefit the account 213 whenever the individual consumes a service provided by entity B 202 through the application 101 because a purchase order of the service contributes to the sales of entity B 202. The same purchase can also benefit entity A 201 because individual A 201 is in the connection hierarchy of entity A 201. In addition, individual A 203 can directly purchase the product of entity A 201, which would benefit entity A 201.

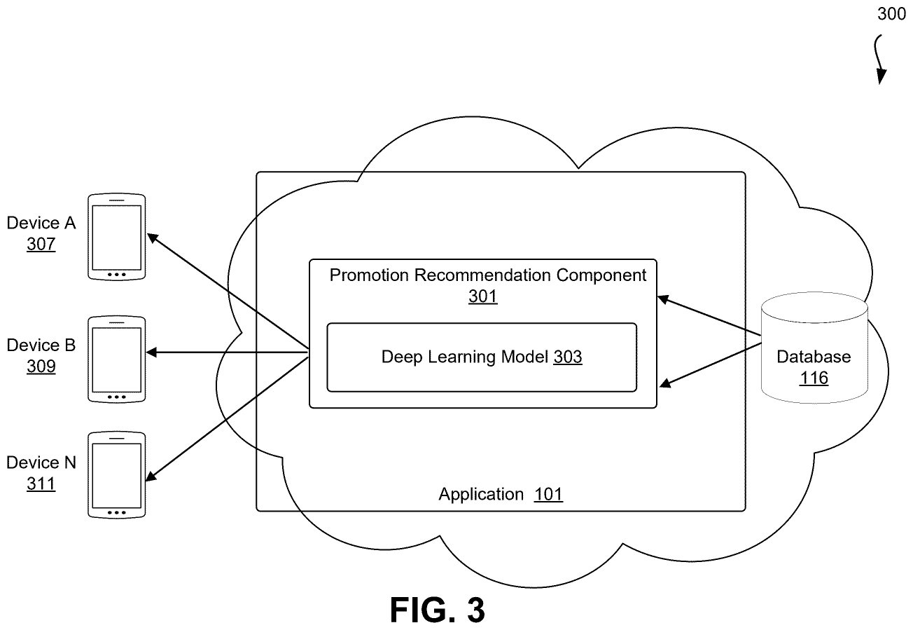

FIG. 3 illustrates a promotion recommendation component in the application 101 according to an embodiment of the disclosure. The promotion recommendation component 301 can recommend items for promotion for each user based on historical data for users stored in the database 116.

In an embodiment, the promotion recommendation component 301 can use any of a plurality of artificial intelligence (AI) models to make the recommendations. For example, the AI models may include, but are not limited to, machine learning models, deep learning models, rule-based models, probabilistic models, or hybrid models. In this embodiment, the promotion recommendation component 301 uses a deep learning-based model 303, which is trained to recommend platform-advertised items that are expected to resonate with the likely demographics of the promoter's contacts. The deep learning model 303 can be trained on a dataset that includes demographic information of the promoters (age, gender, location, education level, interests, etc.), their promotion history, the success rate of these promotions, and the demographics of the users who engaged with the promotions. Training methods may involve supervised learning techniques where the outcome variable indicates the level of engagement or conversion for each item promoted by different demographics. The input can include demographic information of the promoter, historical promotion data tied to promoters with similar demographics, engagement metrics of these promotions, attributes of items that have been successfully promoted by similar demographics in the past. The output would be a list of items ranked by their likelihood of being successfully promoted by the promoter, based on the promoter's demographics.

Once trained, the deep learning model 303 can receive the current promoter's demographic data as input, process this input to predict which items are most likely to be successful for promotion to contacts, which are expected to have similar demographic profiles as the promoter's demographic.

In an embodiment, the deep learning model 303 can recommend a list of items to each of the client devices 307-311, with the items ranked by their likelihood of successful promotion, based on the promoter's demographic. In an embodiment, the deep learning model 303 can be one of convolutional neural network (CNN), a long short-term memory (LSTM) network, a gated recurrent units (GRU) network, or a generative adversarial network (GAN) network, or a transformer network.

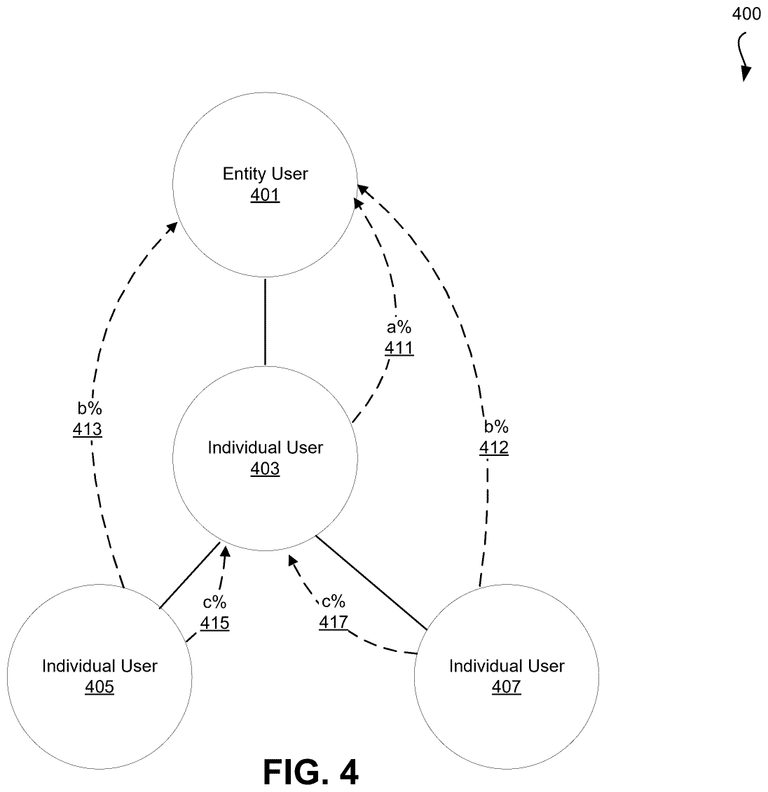

FIG. 4 illustrates an example connection hierarchy 400 according to an embodiment of the disclosure. As shown, the example connection hierarchy 400 is a multi-tiered referral system where each level of user can potentially earn a percentage of the value created by the consumption or activities of users below them in the hierarchy.

As shown, the connection hierarchy 400 has an entity user 401 at the very top and functions as the primary referrer that can gain value from the activities of the users below it in the hierarchy 400. An individual user 403 positioned directly below the entity user 401 has been referred by the entity user. For example, the individual user 403 joined the application 101 by scanning a scan code of the entity user 401.

Individual users 405 and 407 at the third level of the hierarchy and may have been referred to by the individual user 403. For example, both users 405 and 407 were social media contacts that joined the application 101 in response to a promotion of individual user 403.

Each of the percentages 411-417 indicates a portion of a consumption by a user below as a referral point. Each specific percentage can be determined by the rules of the referral program implemented by the application 101. The connection hierarchy 400 is designed to incentivize users to promote the platform 101 and its items to new users and to foster a network of consumption that benefits all involved in the referral chains.

In an embodiment, between two users at different levels below a referrer user, the one at the lower level would contribute a smaller percentage of its consumption to the referrer user than the one at the higher level. Therefore, a % is larger than b % because the individual user 403 corresponding to a % is at a higher level than the individual user 405 corresponding to b %.

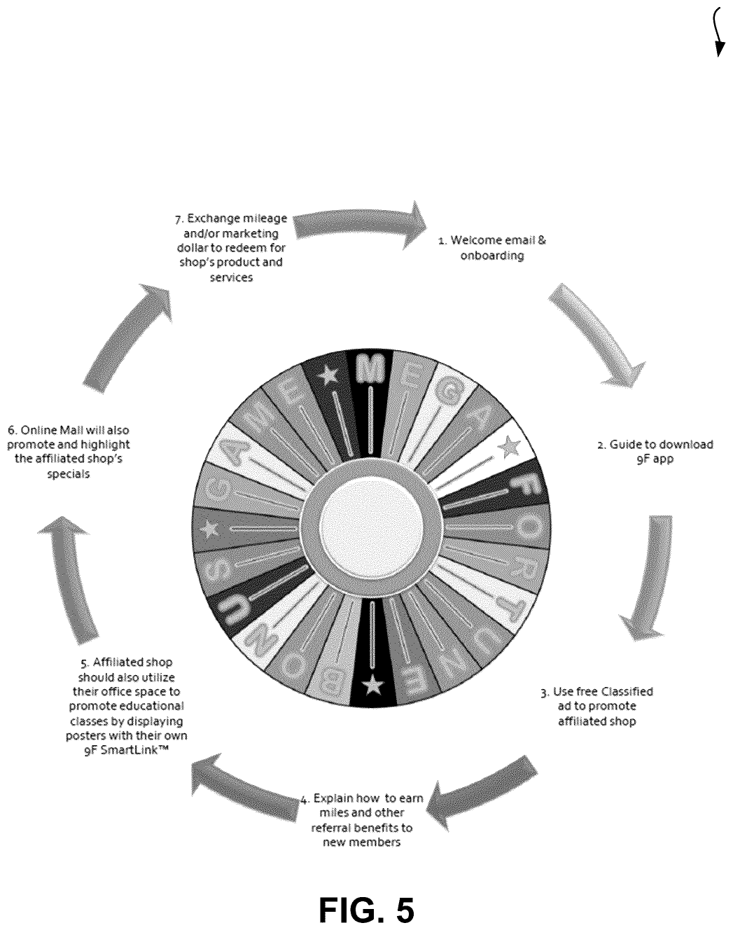

FIG. 5 illustrates a process 500 of serving new users of the application 101 according to an embodiment of the disclosure. The process 500 can be performed by a processing logic that may include software, hardware, or a combination thereof.

At step 1, new users receive a welcome email and are guided through the onboarding process, establishing their initial engagement with the platform. At step 2, the users are provided with instructions to download the platform's client app to manage their account and participate in promotions. At step 3, an offer is made to use a free classified ad service to promote an entity affiliated with the platform 101 (e.g., an entity user), which helps increase visibility and potentially drive sales. At step 4, the application 101 explains how to earn miles and other referral benefits to new members. At step 5, an affiliated entity to be promoted is encouraged to make use of their physical space to promote educational offerings by displaying posters that have a QR code or link (e.g., 9F SmartLink™) to encourage sign-ups or participation. At step 5, the application 101 (e.g., a web-based mall) can support the affiliated entity by promoting its special deals, thereby providing them with additional reach. At step 7, a promoting user can redeem the user's accumulated values (e.g., referral points, reward points, mileage, or dollar values) for products and services offered by the affiliated entity, closing the loop of engagement and incentive for participation.

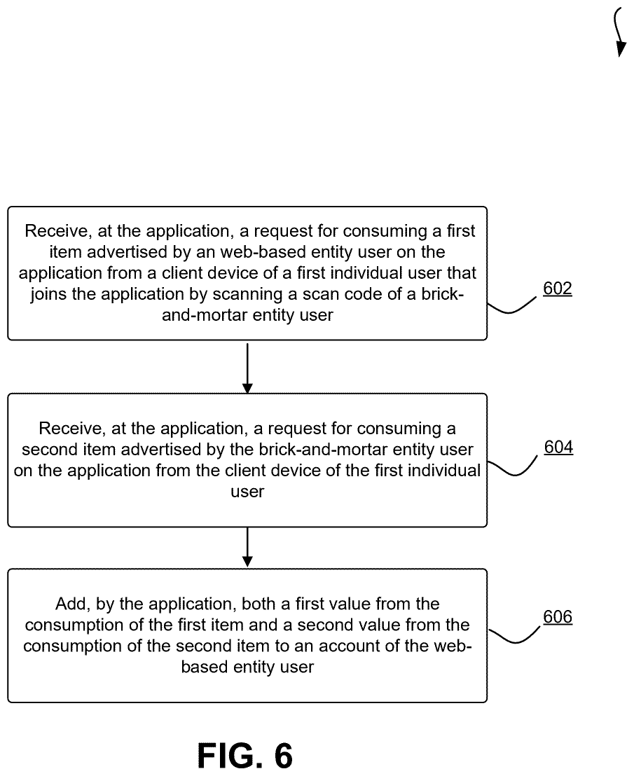

FIG. 6 illustrates a process 600 of sharing values among entities through an application according to an embodiment of the disclosure. The process 600 can be performed by a processing logic that may include software, hardware, or a combination thereof. For example, the process 600 can be performed by the application 101 as described in FIG. 1.

At step 602, the processing logic receives a request for consuming a first item advertised by ana web-based entity user on the application from a client device of a first individual user that joins the application by scanning a scan code of a brick-and-mortar entity user.

At step 604, the processing logic receives a request for consuming a second item advertised by the brick-and-mortar entity user on the application from the client device of the first individual user.

At step 606, the processing logic adds both a first value from the consumption of the first item and a second value from the consumption of the second item to an account of the web-based entity user.

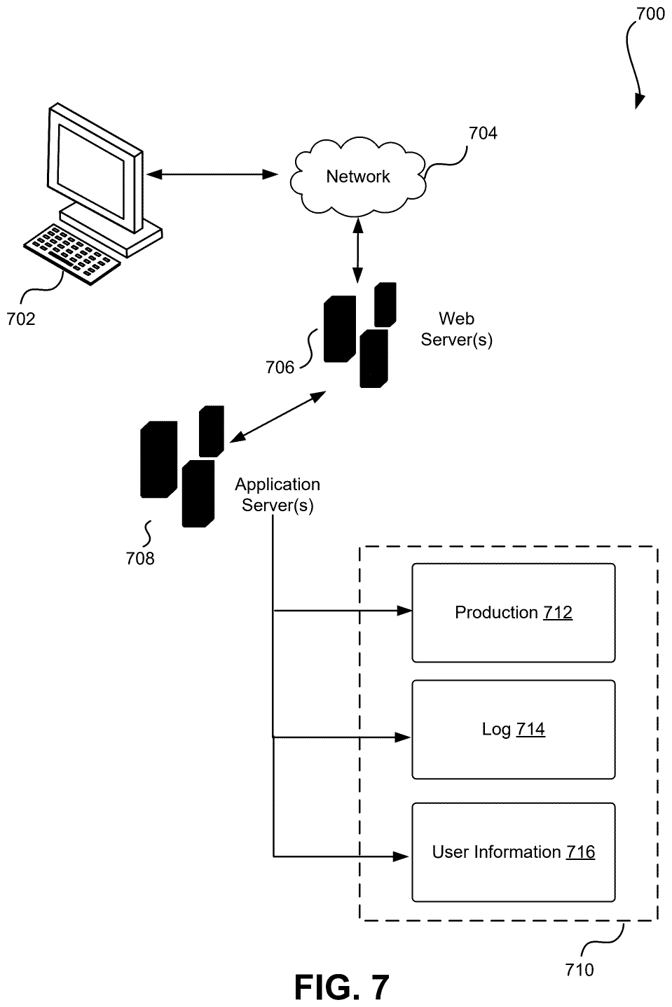

FIG. 7 illustrates aspects of an example system 700 for implementing aspects in accordance with an embodiment. As will be appreciated, although a web-based system is used for purposes of explanation, different systems may be used, as appropriate, to implement various embodiments. In an embodiment, the system includes an electronic client device 702, which includes any appropriate device operable to send and/or receive requests, messages, or information over an appropriate network 704 and convey information back to a user of the device. Examples of such client devices include personal computers, cellular or other mobile phones, handheld messaging devices, laptop computers, tablet computers, set-top boxes, personal data assistants, embedded computer systems, electronic book readers, and the like. In an embodiment, the network includes any appropriate network, including an intranet, the Internet, a cellular network, a local area network, a satellite network or any other such network and/or combination thereof, and components used for such a system depend at least in part upon the type of network and/or system selected. Many protocols and components for communicating via such a network are well known and will not be discussed herein in detail. In an embodiment, communication over the network is enabled by wired and/or wireless connections and combinations thereof. In an embodiment, the network includes the Internet and/or other publicly addressable communications network, as the system includes a web server 706 for receiving requests and serving content in response thereto, although for other networks an alternative device serving a similar purpose could be used as would be apparent to one of ordinary skill in the art.

In an embodiment, the illustrative system includes at least one application server 708 and a data store 710, and it should be understood that there can be several application servers, layers or other elements, processes or components, which may be chained or otherwise configured, which can interact to perform tasks such as obtaining data from an appropriate data store.

In an embodiment, the application server provides access control services in cooperation with the data store and generates content including but not limited to text, graphics, audio, video and/or other content that is provided to a user associated with the client device by the web server in the form of HyperText Markup Language (“HTML”), Extensible Markup Language (“XML”), JavaScript, Cascading Style Sheets (“CSS”), JavaScript Object Notation (JSON), and/or another appropriate client-side or other structured language. Content transferred to a client device, in an embodiment, is processed by the client device to provide the content in one or more forms including but not limited to forms that are perceptible to the user audibly, visually and/or through other senses. The handling of all requests and responses, as well as the delivery of content between the client device 702 and the application server 708, in an embodiment, is handled by the web server using PHP: Hypertext Preprocessor (“PHP”), Python, Ruby, Perl, Java, HTML, XML, JSON, and/or another appropriate server-side structured language in this example. In an embodiment, operations described herein as being performed by a single device are performed collectively by multiple devices that form a distributed and/or virtual system.

The data store 710, in an embodiment, includes several separate data tables, databases, data documents, dynamic data storage schemes and/or other data storage mechanisms and media for storing data relating to a particular aspect of the present disclosure. In an embodiment, the data store illustrated includes mechanisms for storing production data 712 and user information 716, which are used to serve content for the production side. The data store also is shown to include a mechanism for storing log data 714, which is used, in an embodiment, for reporting, computing resource management, analysis or other such purposes. In an embodiment, other aspects such as page image information and access rights information (e.g., access control policies or other encodings of permissions) are stored in the data store in any of the above listed mechanisms as appropriate or in additional mechanisms in the data store 710.

The data store 710, in an embodiment, is operable, through logic associated therewith, to receive instructions from the application server 708 and obtain, update or otherwise process data in response thereto, and the application server 708 provides static, dynamic, or a combination of static and dynamic data in response to the received instructions. In an embodiment, dynamic data, such as data used in web logs (blogs), news services, and other such applications, are generated by server-side structured languages as described herein or are provided by a content management system (“CMS”) operating on or under the control of the application server. In an embodiment, a user, through a device operated by the user, submits a search request for a certain type of item. In this example, the data store accesses the user information to verify the identity of the user, accesses the catalog detail information to obtain information about items of that type, and returns the information to the user, such as in a result listing on a web page that the user views via a browser on the user device 702. Continuing with this example, information for a particular item of interest is viewed in a dedicated page or window of the browser. It should be noted, however, that embodiments of the present disclosure are not necessarily limited to the context of web pages but are more generally applicable to processing requests in general, where the requests are not necessarily requests for content. Example requests include requests to manage and/or interact with computing resources hosted by the system 700 and/or another system, such as for launching, terminating, deleting, modifying, reading, and/or otherwise accessing such computing resources.

In an embodiment, each server typically includes an operating system that provides executable program instructions for the general administration and operation of that server and includes a computer-readable storage medium (e.g., a hard disk, random access memory, read only memory, etc.) storing instructions that, if executed by a processor of the server, cause or otherwise allow the server to perform its intended functions (e.g., the functions are performed as a result of one or more processors of the server executing instructions stored on a computer-readable storage medium).

The system 700, in an embodiment, is a distributed and/or virtual computing system utilizing several computer systems and components that are interconnected via communication links (e.g., transmission control protocol (TCP) connections and/or transport layer security (TLS) or other cryptographically protected communication sessions), using one or more computer networks or direct connections. However, it will be appreciated by those of ordinary skill in the art that such a system could operate in a system having fewer or a greater number of components than are illustrated in FIG. 7. Thus, the depiction of the system 700 in FIG. 7 should be taken as being illustrative in nature and not limiting to the scope of the disclosure.

The various embodiments further can be implemented in a wide variety of operating environments, which in some cases can include one or more user computers, computing devices or processing devices that can be used to operate any of a number of applications. In an embodiment, user or client devices include any of a number of computers, such as desktop, laptop or tablet computers running a standard operating system, as well as cellular (mobile), wireless and handheld devices running mobile software and capable of supporting a number of networking and messaging protocols, and such a system also includes a number of workstations running any of a variety of commercially available operating systems and other known applications for purposes such as development and database management. In an embodiment, these devices also include other electronic devices, such as dummy terminals, thin-clients, gaming systems and other devices capable of communicating via a network, and virtual devices such as virtual machines, hypervisors, software containers utilizing operating-system level virtualization and other virtual devices or non-virtual devices supporting virtualization capable of communicating via a network.

In an embodiment, a system utilizes at least one network that would be familiar to those skilled in the art for supporting communications using any of a variety of commercially available protocols, such as Transmission Control Protocol/Internet Protocol (“TCP/IP”), User Datagram Protocol (“UDP”), protocols operating in various layers of the Open System Interconnection (“OSI”) model, File Transfer Protocol (“FTP”), Universal Plug and Play (“UpnP”), Network File System (“NFS”), Common Internet File System (“CIFS”) and other protocols. The network, in an embodiment, is a local area network, a wide-area network, a virtual private network, the Internet, an intranet, an extranet, a public switched telephone network, an infrared network, a wireless network, a satellite network, and any combination thereof. In an embodiment, a connection-oriented protocol is used to communicate between network endpoints such that the connection-oriented protocol (sometimes called a connection-based protocol) is capable of transmitting data in an ordered stream. In an embodiment, a connection-oriented protocol can be reliable or unreliable. For example, the TCP protocol is a reliable connection-oriented protocol. Asynchronous Transfer Mode (“ATM”) and Frame Relay are unreliable connection-oriented protocols. Connection-oriented protocols are in contrast to packet-oriented protocols such as UDP that transmit packets without a guaranteed ordering.

In an embodiment, the system utilizes a web server that runs one or more of a variety of server or mid-tier applications, including Hypertext Transfer Protocol (“HTTP”) servers, FTP servers, Common Gateway Interface (“CGI”) servers, data servers, Java servers, Apache servers, and business application servers. In an embodiment, the one or more servers are also capable of executing programs or scripts in response to requests from user devices, such as by executing one or more web applications that are implemented as one or more scripts or programs written in any programming language. In an embodiment, the one or more servers also include database servers.

In an embodiment, the system includes a variety of data stores and other memory and storage media as discussed above that can reside in a variety of locations, such as on a storage medium local to (and/or resident in) one or more of the computers or remote from any or all of the computers across the network. In an embodiment, the information resides in a storage-area network (“SAN”) familiar to those skilled in the art and, similarly, any necessary files for performing the functions attributed to the computers, servers or other network devices are stored locally and/or remotely, as appropriate. In an embodiment where a system includes computerized devices, each such device can include hardware elements that are electrically coupled via a bus, the elements including, for example, at least one central processing unit (“CPU” or “processor”), at least one input device (e.g., a mouse, keyboard, controller, touch screen, or keypad), at least one output device (e.g., a display device, printer, or speaker), at least one storage device such as disk drives, optical storage devices, and solid-state storage devices such as random access memory (“RAM”) or read-only memory (“ROM”), as well as removable media devices, memory cards, flash cards, etc., and various combinations thereof.

In an embodiment, such a device also includes a computer-readable storage media reader, a communications device (e.g., a modem, a network card (wireless or wired), an infrared communication device, etc.), and working memory as described above where the computer-readable storage media reader is connected with, or configured to receive, a computer-readable storage medium, representing remote, local, fixed, and/or removable storage devices as well as storage media for temporarily and/or more permanently containing, storing, transmitting, and retrieving computer-readable information. In an embodiment, the system and various devices also typically include a number of software applications, modules, services, or other elements located within at least one working memory device, including an operating system and application programs, such as a client application or web browser. In an embodiment, customized hardware is used and/or particular elements are implemented in hardware, software (including portable software, such as applets), or both. In an embodiment, connections to other computing devices such as network input/output devices are employed.

In an embodiment, storage media and computer readable media for containing code, or portions of code, include any appropriate media known or used in the art, including storage media and communication media, such as but not limited to volatile and non-volatile, removable and non-removable media implemented in any method or technology for storage and/or transmission of information such as computer readable instructions, data structures, program modules or other data, including RAM, ROM, Electrically Erasable Programmable Read-Only Memory (“EEPROM”), flash memory or other memory technology, Compact Disc Read-Only Memory (“CD-ROM”), digital versatile disk (DVD) or other optical storage, magnetic cassettes, magnetic tape, magnetic disk storage or other magnetic storage devices or any other medium which can be used to store the desired information and which can be accessed by the system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed but, on the contrary, the intention is to cover all modifications, alternative constructions, and equivalents falling within the spirit and scope of the invention, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. Similarly, use of the term “or” is to be construed to mean “and/or” unless contradicted explicitly or by context. The terms “comprising,” “having,” “including,” and “containing” are to be construed as open-ended terms (i.e., meaning “including, but not limited to,”) unless otherwise noted. The term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal. The use of the phrase “based on,” unless otherwise explicitly stated or clear from context, means “based at least in part on” and is not limited to “based solely on.”

Conjunctive language, such as phrases of the form “at least one of A, B, and C,” or “at least one of A, B and C,” (i.e., the same phrase with or without the Oxford comma) unless specifically stated otherwise or otherwise clearly contradicted by context, is otherwise understood within the context as used in general to present that an item, term, etc., may be either A or B or C, any nonempty subset of the set of A and B and C, or any set not contradicted by context or otherwise excluded that contains at least one A, at least one B, or at least one C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}, and, if not contradicted explicitly or by context, any set having {A}, {B}, and/or {C} as a subset (e.g., sets with multiple “A”). Thus, such conjunctive language is not generally intended to imply that certain embodiments require at least one of A, at least one of B and at least one of C each to be present. Similarly, phrases such as “at least one of A, B, or C” and “at least one of A, B or C” refer to the same as “at least one of A, B, and C” and “at least one of A, B and C” refer to any of the following sets: {A}, {B}, {C}, {A, B}, {A, C}, {B, C}, {A, B, C}, unless differing meaning is explicitly stated or clear from context. In addition, unless otherwise noted or contradicted by context, the term “plurality” indicates a state of being plural (e.g., “a plurality of items” indicates multiple items). The number of items in a plurality is at least two but can be more when so indicated either explicitly or by context.

Operations of processes described herein can be performed in any suitable order unless otherwise indicated herein or otherwise clearly contradicted by context. In an embodiment, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In an embodiment, the code is stored on a computer-readable storage medium, for example, in the form of a computer program comprising a plurality of instructions executable by one or more processors. In an embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In an embodiment, code (e.g., executable code or source code) is stored on a set of one or more non-transitory computer-readable storage media having stored thereon executable instructions that, when executed (i.e., as a result of being executed) by one or more processors of a computer system, cause the computer system to perform operations described herein. The set of non-transitory computer-readable storage media, in an embodiment, comprises multiple non-transitory computer-readable storage media, and one or more of individual non-transitory storage media of the multiple non-transitory computer-readable storage media lack all of the code while the multiple non-transitory computer-readable storage media collectively store all of the code. In an embodiment, the executable instructions are executed such that different instructions are executed by different processors—for example, in an embodiment, a non-transitory computer-readable storage medium stores instructions and a main CPU executes some of the instructions while a graphics processor unit executes other instructions. In another embodiment, different components of a computer system have separate processors and different processors execute different subsets of the instructions.

Accordingly, in an embodiment, computer systems are configured to implement one or more services that singly or collectively perform operations of processes described herein, and such computer systems are configured with applicable hardware and/or software that enable the performance of the operations. Further, a computer system, in an embodiment of the present disclosure, is a single device and, in another embodiment, is a distributed computer system comprising multiple devices that operate differently such that the distributed computer system performs the operations described herein and such that a single device does not perform all operations.

The use of any and all examples or exemplary language (e.g., “such as”) provided herein is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for embodiments of the present disclosure to be practiced otherwise than as specifically described herein. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated herein or otherwise clearly contradicted by context.

All references including publications, patent applications, and patents cited herein are hereby incorporated by reference to the same extent as if each reference were individually and specifically indicated to be incorporated by reference and were set forth in its entirety herein.

What is claimed is:

1. A computer-implemented method, comprising:
receiving, at an application, a request for consuming a first item advertised by a web-based entity user on the application from a client device of a first individual user that joins the application by scanning a code of a brick-and-mortar entity user;
receiving, at the application, a request for consuming a second item advertised by the brick-and-mortar entity user on the application from the client device of the first individual user; and
adding, by the application, both a first value from the consumption of the first item and a second value from the consumption of the second item to an account of the web-based entity user.

2. The computer-implemented method of claim 1, further comprising:
receiving, at the application, a request for consuming a third item advertised on the application from a client device of a second individual user that joins the application by scanning a code of the first individual user; and
adding, by the application, a third value from the consumption of the third item to an account of the first individual user.

3. The computer-implemented method of claim 2, wherein the second individual user is one of a plurality of social media contacts of the first individual user that receives incentives related to the third item from the first individual user, and consumes the third item.

4. The computer-implemented method of claim 3, wherein the first individual user recommends the third item to the social media contacts by sharing a web-based link to them.

5. The computer-implemented method of claim 3, wherein the second individual user consumes an item advertised on the application other than the third item recommended by the first individual user.

6. The computer-implemented method of claim 3, wherein the application sends a recommendation to the first individual user to recommend the third item to the social media contacts of the first individual user.

7. The computer-implemented method of claim 6, wherein the recommendation is generated using a deep learning model based on a one or more interests of the first individual user.

8. The computer-implemented method of claim 2, wherein the consumption of the first item, the second item, and the third item includes placing an order for the respective item from the application.

9. The computer-implemented method of claim 8, wherein each of the first value, the second value, and the third value comprise points redeemable for other items, wherein each of the first, second, and third value is proportional to a respective order value.

10. The computer-implemented method of claim 1, wherein the application is hosted by one or more cloud servers.

11. A system, comprising:
one or more processors;
memory that stores computer-executable instructions that, if executed, cause the one or more processors to:
receive, at an application, a request for consuming a first item advertised by a web-based entity user on the application from a client device of a first individual user that joins the application by scanning a scan code of a brick-and-mortar entity user;
receive, at the application, a request for consuming a second item advertised by the brick-and-mortar entity user on the application from the client device of the first individual user; and
add, by the application, both a first value from the consumption of the first item and a second value from the consumption of the second item to an account of the web-based entity user.

12. The system of claim 11, wherein the one or more processors are to:
receive, at the application, a request for consuming a third item advertised on the application from a client device of a second individual user that joins the application by scanning a scan code of the first user; and
add, by the application, a third value from the consumption of the third item to an account of the first individual user.

13. The system of claim 12, wherein the second individual user is one of a plurality of social media contacts of the first individual user that receives recommendation for the third item from the first individual user, and consumes the third item.

14. The system of claim 13, wherein the first individual user recommends the third item to the social media contacts by sharing a weblink to them.

15. The system of claim 13, wherein the second individual user consumes an item advertised on the application other than the third item recommended by the first individual user.

16. The system of claim 13, wherein the application sends a recommendation to the first individual user to recommend the third item to the social media contacts of the first individual user.

17. The system of claim 16, wherein the one or more processors are to use a neural network to generate the recommendation based, at least in part, on location information of the first individual user.

18. The system of claim 12, wherein the consumption of the first item, the second item, and the third item includes placing an order for at least one of the first item, second item, and third item from the application.

19. The system of claim 18, wherein each of the first value, the second value, and the third value comprises points, wherein each of the first, second, and third values is proportional to a respective order value.

20. A non-transitory computer-readable storage medium storing thereon executable instructions that, as a result of being executed by one or more processors of a computer system, cause the computer system to:
receive, at an application, a request for consuming a first item advertised by an web-based entity user on the application from a client device of a first individual user that joins the application by scanning a scan code of a brick-and-mortar entity user;
receive, at the application, a request for consuming a second item advertised by the brick-and-mortar entity user on the application from the client device of the first individual user; and
add, by the application, both a first value from the consumption of the first item and a second value from the consumption of the second item to an account of the web-based entity user.
